(19) United States
(12) Patent Application Publication
(10) Pub. No.: US 2018/0099912 A1
(43) Pub. Date: Apr. 12, 2018

(54) METHODS FOR MANUFACTURING PYROTECHNIC MATERIAL FOR THERMAL BATTERIES

(71) Applicant: EaglePicher Technologies, LLC, Joplin, MO (US)

(72) Inventors: Geoffrey Allen Swift, Joplin, MO (US); James Ferraro, Baxter Springs, KS (US); Charles Lamb, Carthage, MO (US)

(73) Assignee: EaglePicher Technologies, LLC, Joplin, MO (US)

(21) Appl. No.: 15/289,099

(22) Filed: Oct. 7, 2016

(51) Int. Cl. C06B 21/00; H01M 6/36; C06B 29/02

(52) U.S. Cl. CPC C06B 21/0083; H01M 6/36; C06B 29/02; C06B 21/0058; C06B 21/0041

(57) ABSTRACT

Embodiments directed to a method of manufacturing a pyrotechnic article for use with a thermal battery are disclosed. The method includes forming an iron oxide preform from iron oxide powder. The method also includes reducing the iron oxide preform to an iron preform made of metallic iron. The method further includes impregnating the iron preform with an oxidizer to form the pyrotechnic article.

### BACKGROUND

The disclosed subject matter relates to thermal batteries and methods of manufacturing a pyrotechnical material for use with thermal batteries. In particular, the disclosed subject matter relates to the manufacturing of pyrotechnic articles or heat pellets for use with thermal batteries. The pyrotechnic articles or heat pellets are used for activation of thermal batteries.

Thermal batteries are primary reserve batteries that utilize an electrolyte that is inactive and a non-conductive solid at ambient temperatures. Therefore, at ambient temperatures, the electrolyte is solid and inert. When the thermal battery is activated for use, it reaches an operating temperature at which the electrolyte becomes molten and the battery is able to deliver power. As primary electrical sources, thermal batteries deliver energy once activated. The output interval varies from a few seconds to over an hour depending on the battery type, construction, and design.

In order to achieve an activated state, thermal batteries are provided with a pyrotechnic material that is in close proximity to the electrolyte. Once the pyrotechnic material is ignited, the thermal battery reaches a temperature within a predefined range based on the type and amount of pyrotechnic material and the battery becomes active.

### SUMMARY

Various methods for manufacturing thermal batteries are known. However, manufacturing of a pyrotechnic material used for the operation of thermal batteries is a complex and time consuming process. Further, such manufacturing processes require large blenders and hydraulic presses for manufacturing of the pyrotechnic material.

Some related art uses a manufacturing process in which iron oxide powder is first reduced to iron powder. The reduced iron powder is blended with an oxidizer in large blenders. The blended powder is then stored until needed. Further, the powder is consolidated via pressing into pellets on a large hydraulic press. Therefore, the process may have high risks of fire associated with the blending, handling, and pressing of iron powder in the presence of the oxidizer.

Some related art uses an iron-aerogel process to prepare a sintered preform for use with the oxidizer. However, removal of the aerogel from the preform oxidizes the iron. Thus, an additional reduction process is required to obtain the reduced iron preform. Therefore, the process becomes inefficient and time consuming.

It may therefore be beneficial to provide methods of manufacturing a pyrotechnic material for thermal batteries, which are safe and efficient. Specifically, it may be beneficial to manufacture pyrotechnical articles in the form of iron-oxidizer pellets that can be used in thermal batteries as the pyrotechnic material.

It may also be beneficial to provide methods of manufacturing that enable formation of iron pellets from iron oxide powder. The iron oxide powder is pressed into pellets and pre-sintered. Further, the pre-sintered pellets undergo reduction to provide iron pellets. The iron pellets are impregnated with an oxidizer to form a pyrotechnic material for use with thermal batteries.

It may also be beneficial to provide methods of manufacturing of a pyrotechnic article with a tape-casting process. The tape-casting process provides flexibility in manufacturing. The tape-casting process also provides flexibility with regard to shape, size, and various other parameters of the pyrotechnic article.

Some embodiments are directed to a method of manufacturing a pyrotechnic article for use with a thermal battery. The method includes forming an iron oxide preform from iron oxide powder. The method also includes reducing the iron oxide preform to an iron preform made of metallic iron. The method further includes impregnating the iron preform with an oxidizer to form the pyrotechnic article.

Some other embodiments are directed to a method of manufacturing a pyrotechnic pellet for use with a thermal battery. The method includes pressing a volume of iron oxide powder to form an iron oxide pellet. The method also includes reducing the iron oxide pellet to an iron pellet made of metallic iron. The method further includes impregnating the iron pellet with an oxidizer to form the pyrotechnic pellet.

Yet other embodiments are directed to a method of manufacturing a pyrotechnic article for a thermal battery. The method includes forming an iron oxide slip comprising iron oxide powder and a fluid medium. The method also includes depositing the iron oxide slip on a carrier substrate to form a tape-cast iron oxide sheet. The method further includes pre-sintering the tape-cast iron oxide sheet. The method also includes reducing the pre-sintered iron oxide sheet to an iron sheet comprising metallic iron. The method further includes punching the iron sheet to obtain an iron pellet made of metallic iron. The method also includes impregnating the iron pellet with an oxidizer to form the pyrotechnic article.

### BRIEF DESCRIPTION OF DRAWINGS

The foregoing and other aspects of the embodiments disclosed herein are best understood from the following detailed description when read in connection with the accompanying drawings. For the purpose of illustrating the embodiments disclosed herein, there is shown in the drawings embodiments that are presently preferred, it being understood, however, that the embodiments disclosed herein are not limited to the specific instrumentalities disclosed. Included in the drawings are the following figures:

FIG. 1 illustrates an exemplary embodiment of an electrochemical device in accordance with the disclosed subject matter.

FIG. 2 is a block diagram of a method of manufacturing a pyrotechnic article in accordance with the disclosed subject matter.

FIG. 3 illustrates a schematic diagram of a pelletization process in accordance with the disclosed subject matter.

FIG. 4 illustrates a schematic diagram of a pre-sintering process in accordance with the disclosed subject matter.

FIG. 5 illustrates a schematic diagram of a reduction process in accordance with the disclosed subject matter.

FIGS. 6A and 6B illustrate various embodiments of an impregnation process in accordance with the disclosed subject matter.

FIG. 7 is a block diagram of a method of manufacturing a pyrotechnic article in accordance with the disclosed subject matter.

FIG. 8 illustrates a schematic diagram of a tape-casting process in accordance with the disclosed subject matter.

FIG. 9 illustrates a schematic diagram of a pre-sintering process in accordance with the disclosed subject matter.

FIG. 10 illustrates a schematic diagram of a reduction process in accordance with the disclosed subject matter.

FIG. 11 illustrates a schematic diagram of a punching process in accordance with the disclosed subject matter.

FIG. 12 is a flowchart of an exemplary method for manufacturing of a pyrotechnic article in accordance with the disclosed subject matter.

FIG. 13 is a flowchart of an exemplary method for manufacturing a pyrotechnic pellet in accordance with the disclosed subject matter.

FIG. 14 is a flowchart of an exemplary method for manufacturing of a pyrotechnic article in accordance with the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4”.

As used herein, the term “operating temperature” refers to a temperature at which the thermal battery becomes thermally active and is typically from about 350° C. to 600° C., such as from about 450° C. to about 500° C., from about 490° C. to about 560° C., or from about 550° C. to about 600° C.

As used herein, the term “ambient temperature” refers to a temperature at which the thermal battery is in an inactivated state, and is lower than the operating temperature.

### I. Thermal Batteries

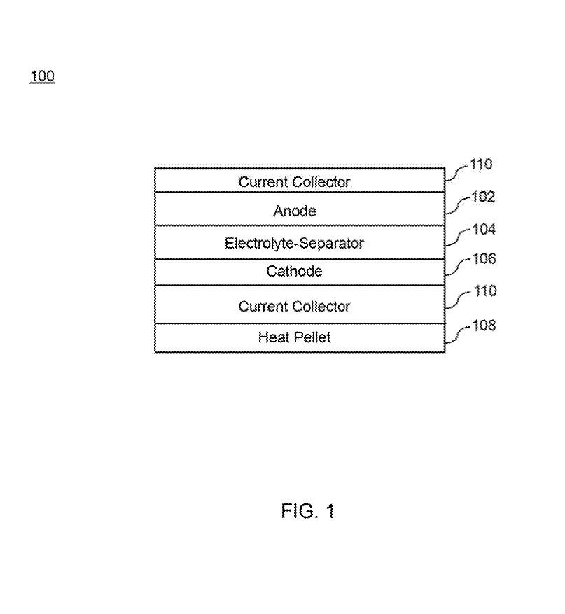

The disclosed subject matter generally relates to a pyrotechnic article or material used for the operation of electrochemical devices, such as thermal batteries. FIG. 1 illustrates an electrochemical device 100, in accordance with various embodiments.

As used herein, an “electrochemical device” may otherwise be referred to as a battery (and in some embodiments, a “thermal battery”), a capacitor, a cell, an electrochemical cell, or the like. It should be understood that these references are not limiting, and any device that involves electron transfer between an electrode and an electrolyte is contemplated within the scope of the present disclosure. Further, an electrochemical device may refer to a single or multiple connected electrochemical devices, electrochemical cells, batteries or capacitors capable of supplying energy to a load, and none of the references herein to any particular device should be considered to limit the disclosure in any way. In one or more embodiments of the present disclosure, the electrochemical device 100 is a thermal battery. The electrochemical device 100 is hereinafter referred to as “the thermal battery 100”.

The thermal battery 100 includes an anode 102, a cathode 106 and an electrolyte-separator 104. In some embodiments, the anode 102 of the thermal battery 100 is made of an alkali or alkaline earth metal or alloy. For example, the anode 102 can include lithium metal or a lithium alloy, such as lithium aluminum, lithium silicon, or lithium boron.

The electrolyte-separator 104 acts as a separator between the anode 102 and the cathode 106 and remains solid until activation. In some embodiments, the electrolyte-separator 104 includes an inorganic salt electrolyte that is a non-conductive solid at ambient temperatures. In some embodiments, the electrolyte-separator 104 can include, but is not restricted to, eutectic electrolytes, for example lithium chloride-potassium chloride (LiCl—KCl) or a halide electrolyte mixture of LiCl—LiF—LiBr.

The cathode 106 present in the thermal battery 100 may vary in accordance with a variety of design parameters and generally includes a metal oxide or metal sulfide. For example, the cathode 106 can include, but is not restricted to, materials such as iron oxide (Fe₃O₄), iron disulfide (FeS₂) or cobalt disulfide (CoS₂).

The thermal battery 100 further includes a heat pellet 108 (hereinafter referred to as “the pyrotechnic article 108”). In some embodiments, the pyrotechnic article 108 acts as a heat source for the thermal battery 100. When operation of the thermal battery 100 is desired, an external stimulus is applied to the thermal battery 100. For example, an electrical current may be applied to the thermal battery 100 to set off an electric match or an electro-active squib, or a mechanical force (e.g., mechanical shock) may be applied to set off a concussion primer (not shown). The external stimulus causes the pyrotechnic article 108 to ignite, thereby releasing heat. Further, the heat produced from the pyrotechnic article 108 causes the previously solid electrolyte-separator 104 to melt and become conductive, which allows the thermal battery 100 to provide power for a desired application. In an embodiment, the pyrotechnic material 108 is iron-potassium perchlorate (Fe—KClO₄). In an alternate embodiment, the pyrotechnic material 108 may be iron-lithium perchlorate (Fe—LiClO₄).

The various components of the thermal battery 100 may be prepared by consolidating powders via a mechanical pressing operation to produce pellets or wafers. Thermal batteries using pressed components may be prepared by assembling, in stacks, the various components, such as the anode 102, the electrolyte-separator 104, the cathode 106, and the pyrotechnic article 108. Assembly of one each of the anode 102, the electrolyte-separator 104, and the cathode 106 comprises a single electrochemical cell. In some embodiments, multiple cells may be stacked in series to produce the thermal battery 100. In other embodiments, the thermal battery 100 may include a single electrochemical cell. In some embodiments, the thermal battery 100 may also include a pair of current collectors 110. One of the current collectors 110 is provided adjacent to the anode 102, while the other current collector 110 is provided adjacent to the cathode 110. In some embodiments, each of the current collectors 110 is a carrier metal substrate having the active ingredients of the anode 102 or the cathode 106. The thermal battery 100, as illustrated in FIG. 1, is exemplary in nature, and embodiments are also intended to include or otherwise cover any other design or configuration of the thermal battery 100.

### II. Manufacturing Method Using Pelletization

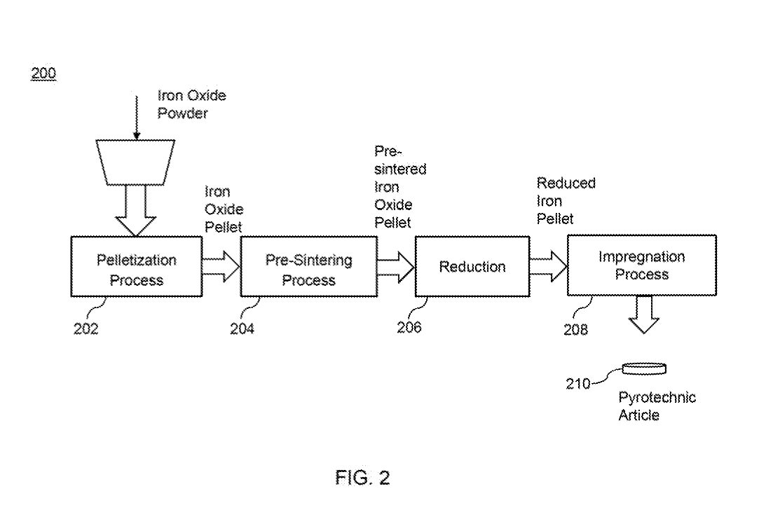

FIG. 2 illustrates a block diagram of a method 200 of manufacturing of a pyrotechnic article 210 in accordance with the disclosed subject matter. The method 200 includes a pelletization process 202, a pre-sintering process 204, a reduction process 206 and an impregnation process 208 to form the pyrotechnic article 210.

The method 200 includes processing a volume of iron oxide powder to form the pyrotechnic article 210. The volume of iron oxide powder may contain binders, lubricants, or moisture. During the pelletization process 202, the volume of iron oxide powder is pressed to form an iron oxide preform. In some embodiments, the iron oxide preform can be an iron oxide pellet. The volume of iron oxide powder may depend on various parameters, such as a desired volume and a desired porosity of the pyrotechnic article 210. A pressure applied during the pelletization process 202 may also depend on the desired volume and porosity of the pyrotechnic article 210. The pelletization process 202 can be performed on a press such as, but not restricted to, a mechanical press, a hydraulic press, or an isostatic press. In some embodiments, the pelletization process 202 may produce multiple iron oxide pellets that form multiple such pyrotechnic articles 210. In some embodiments, a hot press may be used, simultaneously accomplishing the pelletization process 202 and the pre-sintering process 204.

The pelletization process 202 is followed by the pre-sintering process 204. During the pre-sintering process 204, the iron oxide pellets are heated to a particular temperature for a duration of time. The pre-sintering process 204 removes impurities and various other components, such as residual moisture, binders, and lubricants from the iron oxide pellets. Therefore, the pre-sintering process 204 may improve the quality of the iron oxide pellets. In some embodiments, the iron oxide pellets are pre-sintered in air to densify the iron oxide pellets. In alternative embodiment, the pre-sintering process 204 may be optional and the iron oxide pellets may be directly subjected to the reduction process 206.

Next, the pre-sintered iron oxide pellets are reduced to iron pellets by the reduction process 206. The iron pellets may be substantially made of metallic iron. During the reduction process 206, oxygen is removed from the pre-sintered iron oxide pellets. In some embodiments, the reduction process 206 may be carried out in the presence of various chemical reductants, for example, but not restricted to, hydrogen, carbon, carbon monoxide. Further, the reduction process 206 may require heating the pre-sintered iron oxide pellets in presence of the reductants. In an exemplary embodiment, the reductant used for the reduction of the pre-sintered iron oxide pellets to the iron pellets is hydrogen gas.

Further, during the impregnation process 208, the reduced iron pellet is impregnated with an oxidizer to produce the pyrotechnic material 210. In some embodiments, the oxidizer can be, but is not restricted to, potassium perchlorate, lithium perchlorate, or potassium nitrate. The impregnation process 208 can include methods, such as spraying a solution of the oxidizer dissolved in a solvent on the iron pellet or immersion of the iron pellet in the solution of the oxidizer and the solvent.

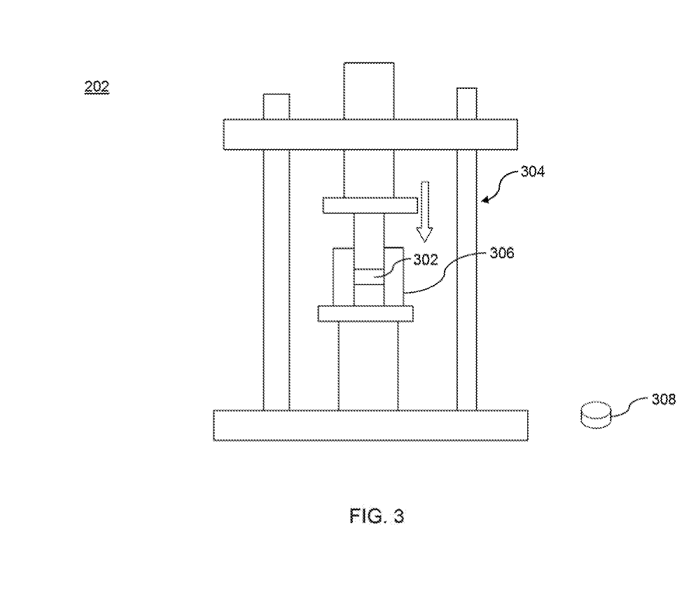

FIG. 3 illustrates a schematic of the pelletization process 202. The pelletization process 202 is configured to compress or mold a material into the shape of a pellet. In an exemplary embodiment, the pelletization process 202 is configured to convert a volume of iron oxide powder 302 to an iron oxide pellet 308. In some embodiments, the pelletization process 202 may include a pellet press 304 to perform the pelletization process 202. The pellet press 304 can be any type of press, such as, but not restricted to, a mechanical press, a hydraulic press, or an isostatic press. Further, pressing is performed in a closed die cavity 306. In some embodiments, the pelletization process 202 requires simultaneous action of top and bottom punches (not shown) in the closed die cavity 306. The pelletization process 202 may form pellets of any suitable size and shape. Further, the size and the shape of the closed die cavity 306 can be changed in order to change the shape and size of the iron oxide pellet 308. In some embodiments, the iron oxide pellet 308 can be cylindrical, cuboidal, and the like. In an embodiment, the shape and size of the iron oxide pellet 308 is chosen based on specifications of the thermal battery 100 (shown in FIG. 1). In other embodiments, the pelletization process 202 is performed to form multiple iron oxide pellets 308. In some embodiments, the pelletization process 202 can be performed manually. In some other embodiments, the pelletization process 202 can be performed automatically by a controller communicably coupled to the pellet press 304. Embodiments are intended to include or otherwise over any equipment that can perform the pelletization process 202 to convert the volume of iron oxide powder 302 to the iron oxide pellet 308.

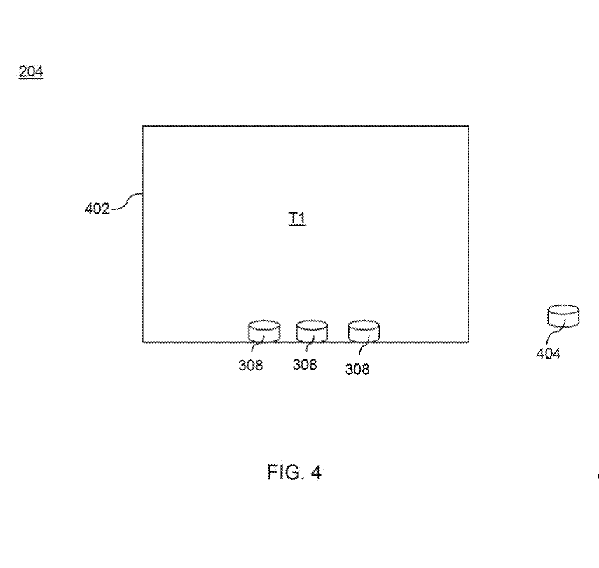

FIG. 4 illustrate a schematic of the pre-sintering process 204. The pre-sintering process 204 removes impurities, residual moisture, binders, and lubricants from the iron oxide pellet 308 to form a pre-sintered iron oxide pellet 404. The pre-sintering process 204 may also improve a strength of the pre-sintered iron oxide pellet 404. In some embodiments, multiple iron oxide pellets 308 undergo the pre-sintering process 204 simultaneously. The pre-sintering process 204 starts with a gradual heating of the iron oxide pellet 308 in a pre-sintering furnace 402 from room temperature to a predefined temperature ‘T1’. In some embodiments, the predefined temperature ‘T1’ can be approximately 800° C. In alternative embodiments, the predefined temperature ‘T1’ can be between about 1325 and 1375° C. depending upon the composition, shape and/or dimensions of the iron oxide pellet 308. The predefined temperature ‘T1’ may also vary in accordance with the impurities present in the iron oxide pellet 308. At the predefined temperature ‘T1’, the impurities associated with the iron oxide pellet 308 are burnt out to form the pre-sintered iron oxide pellet 404. In some embodiments, the pre-sintering process 204 may be conducted in presence of air. Further, a pressure of air within the pre-sintering furnace 402 may be increased above atmospheric pressure to obtain a desired compaction of the iron oxide pellet 308. In alternative embodiments, the pre-sintering process 204 may be optional, and the iron oxide pellet 308 may be directly subjected to the reduction process 206.

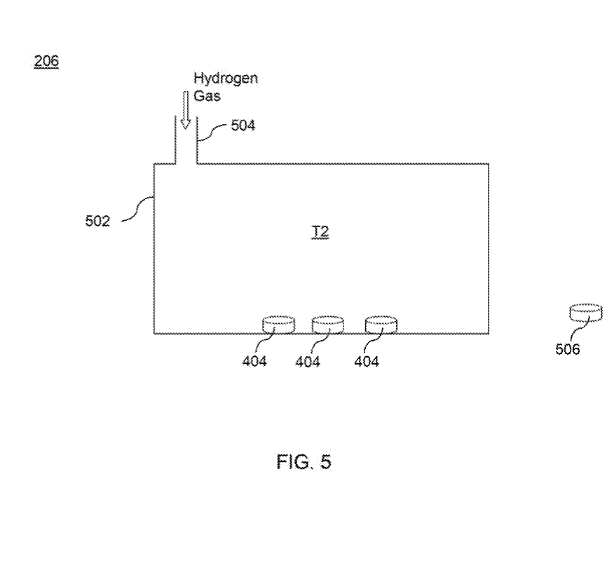

FIG. 5 illustrates a schematic of the reduction process 206. In an embodiment, the reduction process 206 reduces the pre-sintered iron oxide pellet 404 to an iron pellet 506. In some embodiments, the reduction process 206 is carried out in a reduction furnace 502. In further embodiments, multiple pre-sintered iron oxide pellets 404 may be simultaneously subjected to the reduction process 206 within the reduction furnace 502. The reduction furnace 502 may be provided with an opening 504 at the top. The opening 504 is provided for entry of reductant gases required for the reduction of the iron oxide present in the pre-sintered iron oxide pellet 404. In an exemplary embodiment, the reduction process 206 is carried out in the presence of hydrogen gas. In other embodiments, carbon based reductants, such as coke and/or carbon monoxide, may also be used. The pre-sintered iron oxide pellet 404 is exposed to hydrogen gas at a predetermined range of temperature for carrying out the reduction process 206. The pre-sintered iron oxide pellet 404 contacts and reacts with the hydrogen gas at a temperature ‘T2’ in the reduction furnace 502. In some embodiments, the temperature ‘T2’ lies in a range from about 500 to 1000° C. In other embodiments, the temperature ‘T2’ lies in a range from about 600 to 800° C. In some embodiments, a predetermined pressure may also be maintained within the reduction furnace 502 to facilitate the reduction of the pre-sintered iron oxide pellet 404 to the iron pellet 506. The iron pellet 506 is substantially made of metallic iron. Further, the reduction process 206 may also impart a desired porosity to the reduced iron pellet 506. In some embodiments, the reduction process 206 may also improve the strength of the iron pellet 506 due to in situ sintering. The reduction process 206 may also remove any residual impurities from the iron pellet 506, thereby improving its purity.

In other embodiments, the reduction furnace 502 is also provided with an output opening (not shown) for the removal of waste products formed after the reduction of the pre-sintered iron oxide pellet 404 to the reduced iron pellet 506. Embodiments are also intended to include or otherwise cover any other reduction process for the reduction of the pre-sintered iron oxide pellet 404 to the reduced iron pellet 506. In some embodiments, the reduced iron pellet 506 is cooled down to room temperature within the reduction furnace 502 or a separate inert environment to prevent re-oxidation of the iron pellet 506. In alternative embodiments, the reduction of the pre-sintered iron oxide pellet 404 with hydrogen gas may be accomplished by using a bulk bed layer, a traveling fluidized bed, a circulating fluidized bed, a traveling grate, a rotary kiln, or by means of a vertical indirectly heated unobstructed furnace. Further, the iron pellet 506 formed as a result of the reduction process 206 undergoes the impregnation process 208.

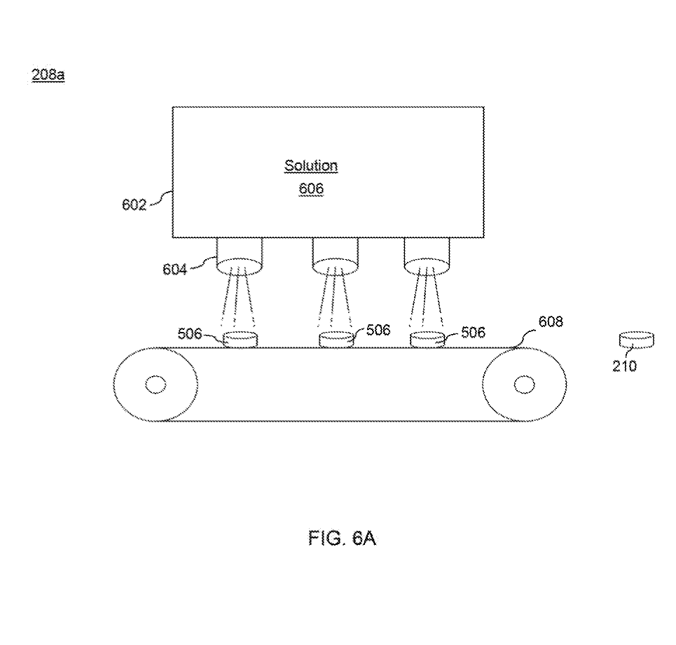

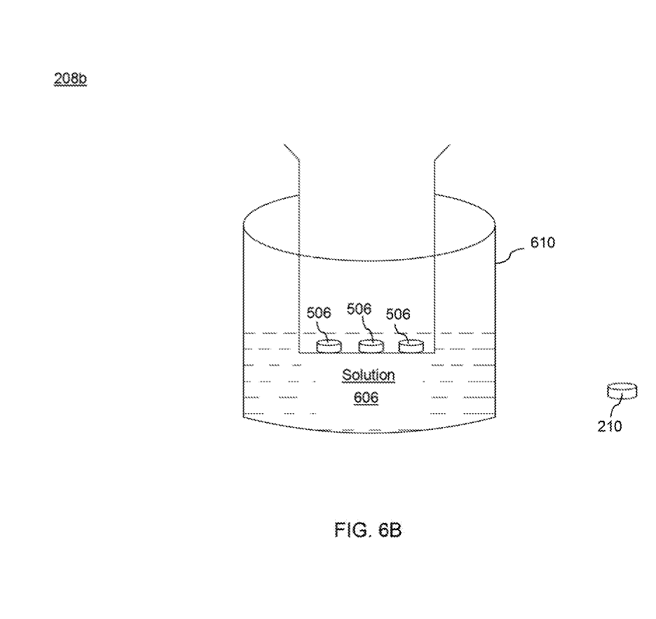

FIGS. 6A and 6B illustrate a first impregnation process 208a and a second impregnation process 208b, respectively. The first and second impregnation process 208a, 208b may be two embodiments of the impregnation process 208. During both the first and second impregnation processes 208a, 208b, the reduced iron pellet 506 is impregnated with an oxidizer to form the pyrotechnic article 210. The pyrotechnic article 210 can be used as the heat pellet 108 in the thermal battery 100 (shown in FIG. 1).

As illustrated in FIG. 6A, the first impregnation process 208a may include a container 602. The container 602 contains a solution 606 of the oxidizer dissolved in a solvent. The container 602 may further include one or more openings 604 to spray the solution 606 of the oxidizer and the solvent on one or more of the iron pellets 506. In some embodiments, the oxidizer may include compounds which can easily dissolve in the solvent. For example, the oxidizer can be, but is not restricted to, potassium perchlorate, potassium nitrate, or lithium perchlorate. Further, the solvent may include a chemical which is easily volatilized such that only the oxidizer is deposited on the surface of the iron pellet 506. An example of the oxidizer-solvent solution can be lithium perchlorate and acetone. The porosity of the reduced iron pellet 506 helps the oxidizer to infuse with the iron pellet 506 to form the pyrotechnic article 210. In some embodiments, multiple iron pellets 506 can be impregnated simultaneously using a conveyor belt 608.

As illustrated in FIG. 6B, the second impregnation process 208b can be performed by immersing the iron pellet 506 into the solution 606 of the oxidizer and the solvent. The solution 606 is contained in a container 610 and the iron pellet 506 is immersed into the solution using a movable tray or any other structure. Alternatively, multiple iron pellets 506 can be immersed into the container 610 for the impregnation process 208b. The impregnation process 208b produces the pyrotechnic article 210.

The first and second impregnation processes 208a, 208b, described above, are exemplary in nature, and embodiments are intended to include or otherwise cover any other impregnation method to form the pyrotechnic article 210 from the iron pellet 506. The pyrotechnic article 210 may be used as the heat pellet 108 in the thermal battery 100 (shown in FIG. 1).

### III. Manufacturing Method Using Tape-Casting

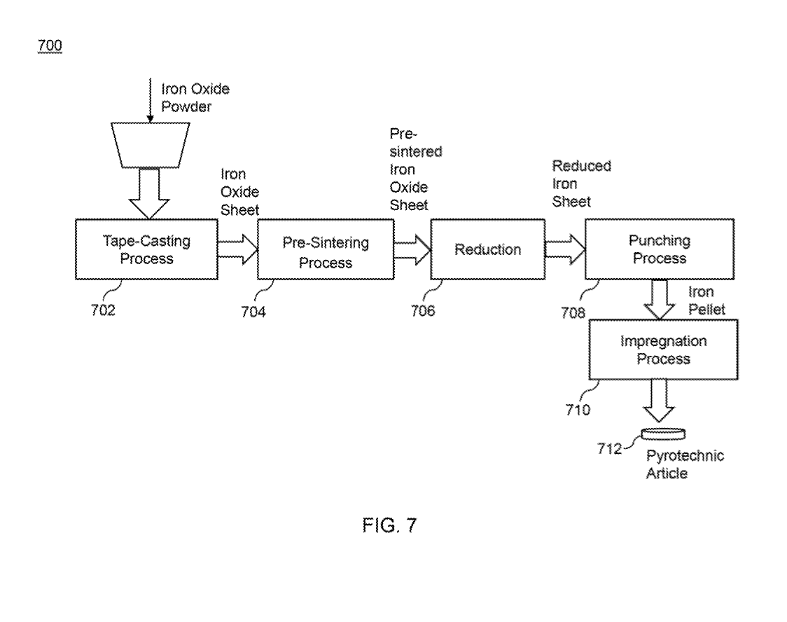

FIG. 7 illustrates a block diagram of a method 700 of manufacturing a pyrotechnic article 712 in accordance with the disclosed subject matter. The method 700 includes a tape-casting process 702, a pre-sintering process 704, a reduction process 706, a punching process 708, and an impregnation process 710 to form the pyrotechnic article 712.

The method 700 is configured to process a volume of iron oxide powder to form an iron oxide preform by the tape-casting process 702. In an exemplary embodiment, the iron oxide preform is large, thin, and flat, i.e., a planar sheet of iron oxide. During the tape-casting process 702, the iron oxide preform is formed by depositing an iron oxide slip on a carrier substrate, thereby forming a tape-cast iron oxide sheet. The tape-cast iron oxide sheet is further processed to form the pyrotechnic article 712.

The method 700 further includes pre-sintering the iron oxide preform or the tape-cast iron oxide sheet. During the pre-sintering process 704, the tape-cast iron oxide sheet is heated to a predetermined temperature for a duration of time. The pre-sintering process 704 removes the impurities and various other components such as, but not restricted to, residual moisture, binders, and lubricants from the tape-cast iron oxide sheet. As such, the pre-sintering process 704 burns out chemicals (for example, binders) associated with the tape-casting process 702 so that such slip-casting chemicals may not interfere with the operation of the thermal battery 100 (shown in FIG. 1). Thus, the pre-sintering process 704 improves the quality of the iron oxide sheet. The pre-sintering process 704 may also improve strength characteristics of the tape-cast iron oxide sheet. In alternative embodiments, the pre-sintering process 704 may be optional and the tape-cast iron oxide sheet can be directly subjected to the reduction process 706.

Next, during the reduction process 706, the pre-sintered iron oxide sheet is reduced to an iron sheet. During the reduction process 706, oxygen is removed from the pre-sintered iron oxide sheet to form the iron sheet made of substantially metallic iron. In some embodiments, the reduction process 706 may be carried out in the presence of various chemicals such as, but not restricted to, hydrogen, carbon, or carbon monoxide.

Further, during the punching process 708, small iron pellets are cut out from the iron sheet using a punch. In some other embodiments, the pellets may be cut from the iron sheet using a machining process. In some embodiments, the iron oxide pellets can have any desirable shape such as, but not restricted to, cylindrical or cuboidal.

During the impregnation process 710, the iron pellets are then impregnated with an oxidizer to produce the pyrotechnic material 712. In some embodiments, the oxidizer can be, but is not restricted to, potassium perchlorate, lithium perchlorate, or potassium nitrate. The impregnation process 710 can include various methods, for example, but not restricted to, spraying a solution of the oxidizer dissolved in a solvent on the iron pellets or immersion of the iron pellets into the solution of the oxidizer and the solvent.

In alternative embodiments, the iron sheet can be impregnated with the oxidizer before the punching process 708. The pyrotechnic article 712 can be then punched out to form the impregnated iron sheet.

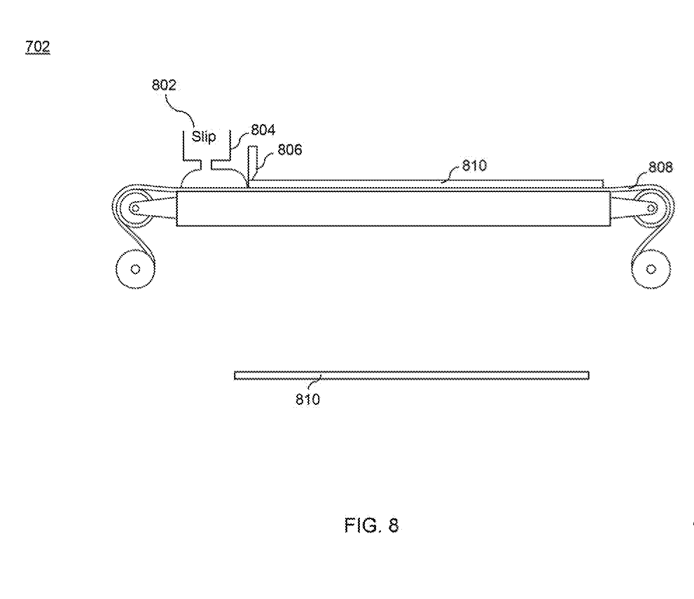

FIG. 8 illustrates a schematic of the tape-casting process 702. During the tape-casting process 702, a tape-cast iron oxide sheet 810 is formed by casting an iron oxide slip 802 onto a carrier substrate 808. The iron oxide slip 802 may be stored in a slip container 804. Further, the iron oxide slip 802 may include iron powder dispersed within a fluid medium. The fluid medium may include various components such as, but not restricted to, a solvent, a dispersant, a binder, and a plasticizer. The solvent may be used to dissolve and homogeneously distribute the other slip components. The dispersant disperses the particles in the iron oxide slip 802 to keep them apart and homogeneously suspended in the iron oxide slip 802. The polymeric binder holds various components of the iron oxide slip 802 together. The plasticizer may be added to the iron oxide slip 802 to add flexibility to the tape-cast iron oxide sheet 810. In some embodiments, the iron oxide slip 802 may be a slurry of the iron powder and the fluid medium.

The tape-casting process 702 includes depositing the slip 802 on the carrier substrate 808 to form the tape-cast iron oxide sheet 810. In some embodiments, the tape-cast iron oxide sheet 810 formed during the tape-casting process 702 can have any desirable shape and size suitable for the operation of the thermal battery 100 (shown in FIG. 1). A blade 806 is also provided to remove unwanted slip from the carrier substrate 808 to provide a smooth and flat tape-cast iron oxide sheet 810. The height of the blade 806 can also be adjusted to get the desired thickness of the tape-cast iron oxide sheet 810. In some embodiments, a drying mechanism (not shown) is used to dry the wet tape-cast iron oxide sheet 810. In an example, the drying mechanism can be a heat source. The tape-cast iron oxide sheet 810 is further processed by the pre-sintering process 704. In some embodiments, the solvent, the dispersant, the binder, and the plasticizer facilitate the fabrication of the tape-cast iron oxide sheet 810. However, such tape-casting chemicals may be burnt out during the drying of the tape-cast iron oxide sheet 810 and the subsequent pre-sintering process 704. As a result, the tape-casting chemicals may not interfere with the operation of the thermal battery 100.

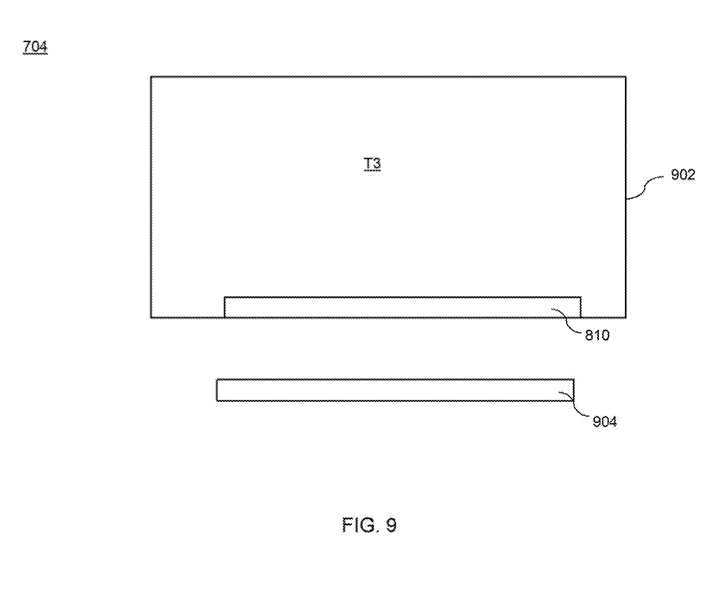

FIG. 9 illustrates a schematic of the pre-sintering process 704. The pre-sintering process 704 removes impurities, residual moisture, binders, plasticizer, dispersant, and lubricants from the tape-cast iron oxide sheet 810 to form a pre-sintered iron oxide sheet 904. Specifically, the pre-sintering process 704 may remove residual tape-casting chemicals from the tape-cast iron oxide sheet 810 and any other impurities. The pre-sintering process 704 may also improve a strength of the pre-sintered iron oxide sheet 904. The pre-sintering process 704 starts with a gradual heating of the tape-cast iron oxide sheet 810 in a pre-sintering furnace 902 from room temperature to a predefined temperature ‘T3’. In some embodiments, the predefined temperature ‘T3’ can be approximately 800° C. In alternative embodiments, the predefined temperature can lie in a range from about 1325 and 1375° C. depending upon the composition, shape and/or dimensions of the tape-cast iron oxide sheet 810. The predefined temperature ‘T3’ may also vary in accordance with the impurities present in the tape-cast iron oxide sheet 810. At the predefined temperature ‘T3’, the impurities in the tape-cast iron oxide sheet 810 are burnt out to form the pre-sintered iron oxide sheet 904. In some embodiments, the pre-sintering process 704 may be conducted in presence of air. Further, a pressure of air within the pre-sintering furnace 902 may be increased above atmospheric pressure to obtain a desired compaction of the tape-cast iron oxide sheet 810. In alternative embodiments, the pre-sintering process 704 may be optional, and the tape-cast iron oxide sheet 810 may be directly subjected to the reduction process 706.

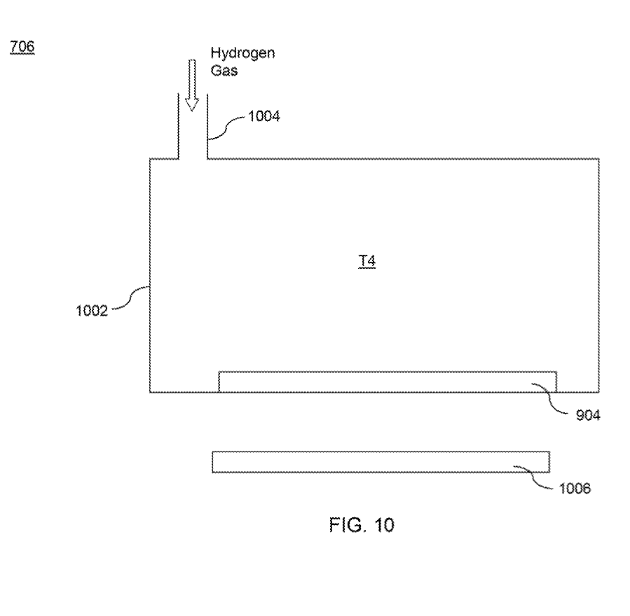

FIG. 10 illustrates a schematic of the reduction process 706. In an embodiment, the reduction process 706 reduces the pre-sintered iron oxide sheet 904 to a reduced iron sheet 1006. In some embodiments, the reduction process 706 is carried out in a reduction furnace 1002. The reduction furnace 1002 may be provided with an opening 1004 at the top. The opening 1004 is provided for entry of reductant gases required for the reduction of the iron oxide present in the pre-sintered iron oxide sheet 904. In an exemplary embodiment, the reduction process 706 is carried out in the presence of hydrogen gas. In other embodiments, carbon based reductants, such as coke and/or carbon monoxide, may also be used. The pre-sintered iron oxide sheet 904 is exposed to hydrogen gas at a predetermined range of temperature for carrying out for the reduction process 706. The pre-sintered iron oxide sheet 904 contacts and reacts with the hydrogen at a temperature ‘T4’ in the reduction furnace 1002. In some embodiments, the temperature ‘T4’ lies in a range from about 500 to 1000° C. In other embodiments, the temperature ‘T4’ lies in a range from about 600 to 800° C. In some embodiments, a predetermined pressure may also be maintained within the reduction furnace 1002 to facilitate the reduction of the pre-sintered iron oxide sheet 904 to the iron sheet 1006. The iron sheet 1006 is substantially made of metallic iron. Further, the reduction process 706 may also impart a desired porosity to the reduced iron sheet 1006. In some embodiments, the reduction process 706 may also improve the strength of the iron sheet 1006 due to in situ sintering. The reduction process 706 may also remove any residual impurities from the iron sheet 1006, thereby improving its purity.

In other embodiments, the reduction furnace 1002 may also include an output opening (not shown) for the removal of waste products formed after the reduction of the pre-sintered iron oxide sheet 904 to the reduced iron sheet 1006. Embodiments are also intended to include or otherwise cover any other reduction process for the reduction of the pre-sintered iron oxide sheet 904 into the reduced iron sheet 1006. In some embodiments, the reduced iron sheet 1006 is cooled down to room temperature within the reduction furnace 1002 or a separate inert environment to prevent re-oxidation of the iron sheet 1006. In alternative embodiments, the reduction of the pre-sintered iron oxide sheet 904 with hydrogen gas may be accomplished by using a bulk bed layer, a traveling fluidized bed, a circulating fluidized bed, a traveling grate, a rotary kiln, or by means of a vertical indirectly heated unobstructed furnace.

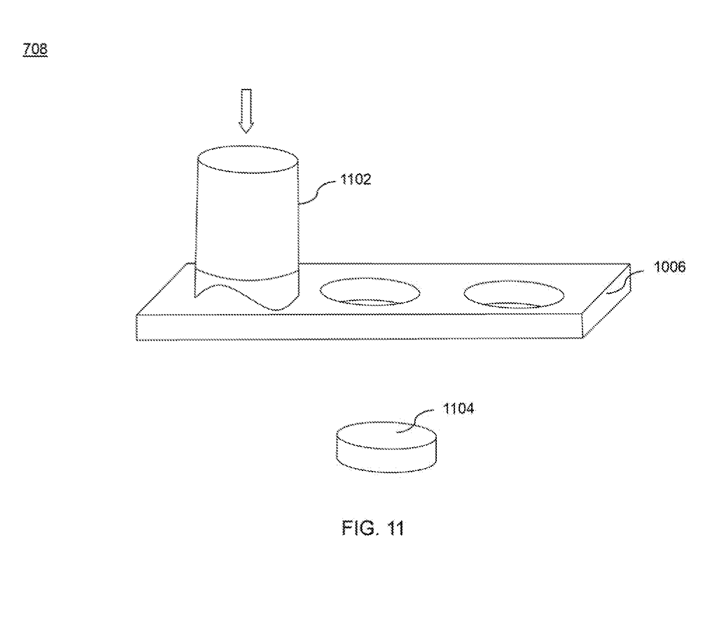

FIG. 11 illustrates a schematic of the punching process 708. During the punching process 708, iron pellets 1104 are punched out from the iron sheet 1006. The punching process 708 involves a punch 1102 that punches out the iron pellets 1104 from the iron sheet 1006. In an exemplary embodiment, the punch 1102 is cylindrical in shape in order to form disc shaped iron pellets 1104 with desired dimensions. In some other embodiments, the punch 1102 can have different shape and size based on the desired shape and size of the iron pellets 1104. Further, the punching process 708 can be performed automatically or manually. The punching process 708, as illustrated in FIG. 11, is exemplary in nature, and embodiments are intended to include or otherwise cover any other process to punch out the iron pellets 1104 from the iron sheet 1006. Further, the iron pellets 1104 are impregnated with an oxidizer to form the pyrotechnic article 712. The pyrotechnical article 712 can be used as the heat pellet 108 in the thermal battery 100 (shown in FIG. 1).

The iron pellet 1104 may be subjected to the impregnation process 710 to form the pyrotechnic article 712. In some embodiments, the impregnation process 710 may be substantially similar to the first impregnation process 208a, as described above with reference to FIG. 6A. Specifically, spraying the solution 600 of the oxidizer and the solvent on one or more of the iron pellets 1104. The porosity of the reduced iron sheet 1006 helps the oxidizer to infuse with the iron pellets 1104 to form the pyrotechnic article 712. In some embodiments, the oxidizer can be any compound which is easily dissolved in the solvent. For example, the oxidizer can be, but is not restricted to, potassium perchlorate, potassium nitrate, or lithium perchlorate. Further, the solvent may be any chemical compound which is easily volatized so as to deposit the oxidizer on the surface of the iron pellets 1104. For example, the solution 606 can be formed by using lithium perchlorate as the oxidizer and acetone as the solvent. In some embodiments, multiple iron pellets 506 can be impregnated simultaneously using a conveyor belt 608.

In some embodiments, the impregnation process 710 may be substantially similar to the second impregnation process 208b, as described above with reference to FIG. 6B. Specifically, the impregnation process 710 can also be performed by immersing the iron pellets 1104 into the solution 606 of the oxidizer and the solvent. The impregnation process 710 produces the pyrotechnic article 712. The first and second impregnation processes 208a and 208b, as illustrated in FIGS. 6A and 6B, are exemplary in nature, and embodiments are intended to include or otherwise cover any other impregnation method to form the pyrotechnic material 712 from the iron pellets 1104.

### IV. Exemplary Embodiments

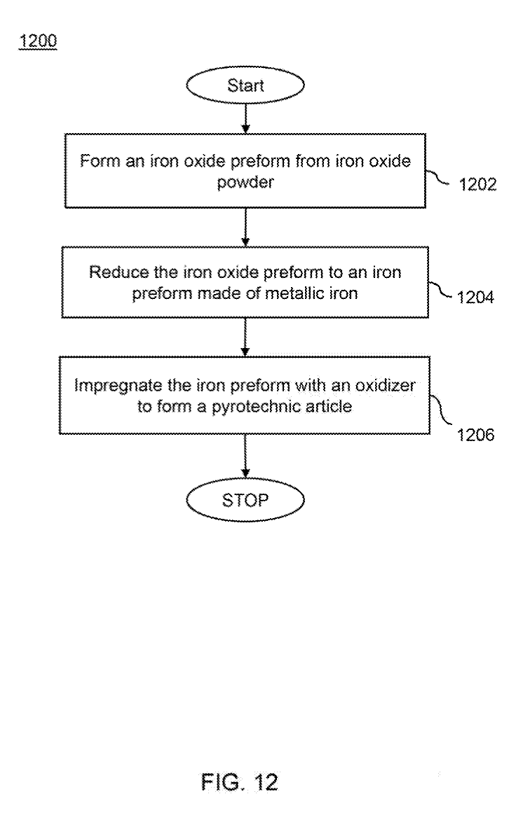

FIG. 12 illustrates a method 1200 of manufacturing a pyrotechnic article for use with a thermal battery in accordance with the disclosed subject matter. This flowchart is merely provided for exemplary purposes, and embodiments are intended to include or otherwise cover any methods or procedures for manufacturing the pyrotechnic article. The method 1200 will be described hereinafter with reference to FIGS. 1 to 11.

In accordance with the flowchart of FIG. 1200, at step 1202, an iron oxide preform is formed from iron oxide powder. In some embodiments, the iron oxide preform is the iron oxide pellet 308, as illustrated in FIG. 3. Further, forming the iron oxide preform includes pressing a volume of iron oxide powder 302 into the iron oxide pellet 308. In some embodiments, the pressing of the volume of iron oxide powder 302 into the iron pellet 308 can be performed using the pelletization process 202. The pelletization process 202 is configured to compress or mold a material into the shape of a pellet. In some embodiments, the pelletization process 202 may include the pellet press 304 to perform the pelletization process 202. The pellet press 304 can be any type of press, such as, but not restricted to, a mechanical press, a hydraulic press, or an isostatic press. In some embodiments, the iron oxide pellet 308 can be cylindrical, cuboidal, disc-shaped, or otherwise as needed for the particular thermal battery 100 being constructed.

In some other embodiments, the iron oxide preform is the tape-cast iron oxide sheet 810, as illustrated in FIG. 8. Further, the tape-casting process 703 may be used to form the tape-cast iron oxide sheet 810. The formation of the tape-cast iron oxide sheet 810 may include forming the iron oxide slip 802 including iron oxide powder and a fluid medium. The fluid medium may include a solvent, a dispersant, a binder, and a plasticizer. During the tape-casting process 703, the iron oxide slip 802 may be deposited on the carrier substrate 808 to form the tape-cast iron oxide sheet 810.

The method 1200 may further include pre-sintering of the iron oxide preform. The pre-sintering process removes impurities, residual moisture, binders, and lubricants from the iron oxide preform. In an embodiment, the pre-sintering process 204 may be used to pre-sinter the iron oxide preform embodied as the iron oxide pellet 308. The pre-sintering process 204 starts with a gradual heating of the iron oxide preform, i.e., the iron oxide pellet 308 in the pre-sintering furnace 402 from room temperature to the predefined temperature ‘T1’. In some embodiments, the predefined temperature ‘T1’ can be approximately 800° C. In alternative embodiments, the predefined temperature ‘T1’ can be between 1325 to 1375° C. depending upon the composition of the iron oxide preform. The predefined temperature ‘T1’ can vary in accordance with the impurities present in the iron oxide preform. In some embodiments, at the predefined temperature ‘T1’, the impurities associated with the iron oxide preform are burnt out to form the pre-sintered iron oxide preform, i.e., the pre-sintered iron oxide pellet 404. In some embodiments, multiple iron oxide preforms or iron oxide pellets 308 may be simultaneously subjected to the pre-sintering process 204.

In some other embodiments, the pre-sintering process 704 may be used to pre-sinter the iron oxide preform embodied as the tape-cast iron oxide sheet 810. The pre-sintering process 704 starts with a gradual heating of the iron oxide preform, i.e., the tape-cast iron oxide sheet 810 in the pre-sintering furnace 902 from room temperature to the predefined temperature 73′. In some embodiments, at the predefined temperature 73′, the impurities associated with the iron oxide preform are burnt out to form the pre-sintered iron oxide preform, i.e., the pre-sintered iron oxide sheet 904.

In alternative embodiments, the pre-sintering process may be optional, and the iron oxide preform may be directly subjected to a reduction process to obtain an iron preform made substantially of metallic iron.

Next, at step 1204, the pre-sintered iron oxide preform is reduced to an iron preform made of metallic iron by a reduction process. The pre-sintered iron oxide preform is exposed to hydrogen gas at a predetermined range of temperature for the reduction process. In other embodiments, carbon based reductants, such as coke and/or carbon monoxide, may also be used. Further, the reduction process may also impart a desired porosity to the reduced iron preforms.

In some embodiments, the reduction process 206 may be used to reduce the iron oxide preform in the form of the pre-sintered iron oxide pellet 404 to the iron pellet 506. In some embodiments, the reduction process 206 is carried out in the reduction furnace 502. In further embodiments, multiple pre-sintered iron oxide pellets 404 may be simultaneously subjected to the reduction process 206 within the reduction furnace 502. The iron oxide pellet 404 is exposed to hydrogen gas at a predetermined range of temperature for carrying out the reduction process 206. The pre-sintered iron oxide pellet 404 contacts and reacts with the hydrogen gas at a temperature ‘T2’ in the reduction furnace 502. In some embodiments, the temperature ‘T2’ lies in a range from about 500 to 1000° C. In other embodiments, the temperature ‘T2’ lies in a range from about 600 to 800° C. The iron preform or the iron pellet 506 is substantially made of metallic iron. Further, the reduction process 206 may also impart a desired porosity to the reduced iron pellet 506. In some embodiments, the reduction process 206 may also improve the strength of the iron pellet 506 due to in situ sintering. The reduction process 206 may also remove any residual impurities from the iron pellet 506, thereby improving its purity.

In some embodiments, the reduction process 706 may be used to reduce the iron oxide preform in the form of the pre-sintered iron oxide sheet 904 to the iron sheet 1006. In some embodiments, the reduction process 706 is carried out in a reduction furnace 1002. The pre-sintered iron oxide sheet 904 is exposed to hydrogen gas at a predetermined range of temperature for carrying out for the reduction process 706. The pre-sintered iron oxide sheet 904 contacts and reacts with the hydrogen at a temperature ‘T4’ in the reduction furnace 1002. In some embodiments, the temperature ‘T4’ lies in a range from about 500 to 1000° C. In other embodiments, the temperature ‘T4’ lies in a range from about 600 to 800° C. In some embodiments, a predetermined pressure may also be maintained within the reduction furnace 1002 to facilitate the reduction of the pre-sintered iron oxide sheet 904 to the iron sheet 1006. The iron preform or the iron sheet 1006 is substantially made of metallic iron. Further, the reduction process 706 may also impart a desired porosity to the reduced iron sheet 1006. In some embodiments, the reduction process 706 may also improve the strength of the iron sheet 1006 due to in situ sintering. The reduction process 706 may also remove any residual impurities from the iron sheet 1006, thereby improving its purity.

At step 1206, the reduced iron preform is impregnated with an oxidizer to form a pyrotechnic article. The pyrotechnic article may be used as a heat pellet in a thermal battery. The impregnation of the iron preform may include spraying the iron preform with a solution of the oxidizer and the solvent. The porosity of the reduced iron preform helps the oxidizer to infuse with the iron preform to form the pyrotechnic article. In some embodiments, the oxidizer can be any compound which easily dissolves in the solvent. For example, the oxidizer can be, but is not restricted to, potassium perchlorate, potassium nitrate, or lithium perchlorate. Further, the solvent may be any chemical compound which is easily volatized so as to deposit the oxidizer on the surface of the iron preform. For example, the solution can be formed by using lithium perchlorate as the oxidizer and acetone as the solvent. In some other embodiments, the impregnation of the iron preform may include immersing the iron preform in the solution of the oxidizer and the solvent.

In some embodiments, the reduced iron preform in the form of the iron pellet 506 may be impregnated by either the first impregnation process 208a or the second impregnation process 208b, as described above with reference to FIGS. 6A and 6B. The first or the second impregnation processes 208a, 208b, when performed on the iron pellet 506, result in the formation of the pyrotechnic article 210 that can be used as the heat pellet 108 in the thermal battery 100 (shown in FIG. 1). In other embodiments, the reduced iron preform in the form of the iron sheet 1006 may be subjected to the punching process 708, as described above with reference to FIG. 11, to form the iron pellet 1104. One or more of the iron pellets 1104 may be then subjected to either of the first impregnation process 208a or the second impregnation process 208b, as described above with reference to FIGS. 6A and 6B. The first or the second impregnation processes 208a, 208b, when performed on the iron pellet 1104, result in the formation of the pyrotechnic article 712 that can be used as the heat pellet 108 in the thermal battery 100.

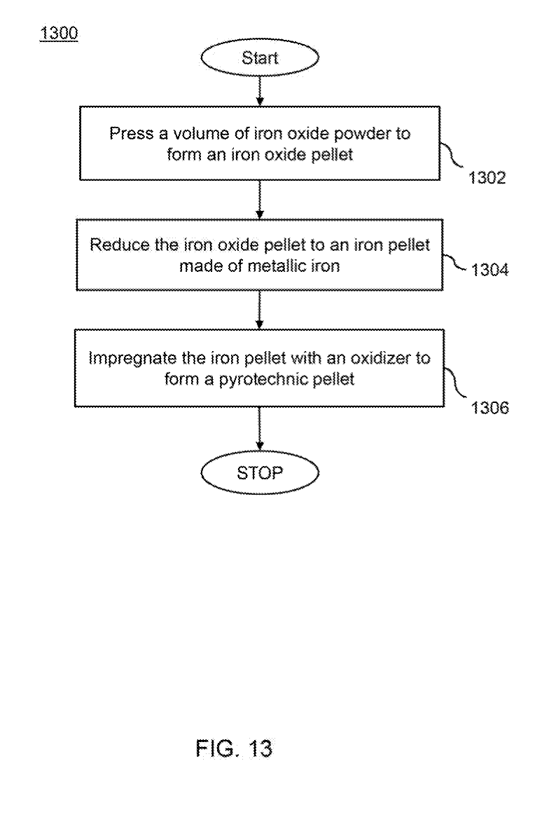

FIG. 13 is a flowchart of a method 1300 for manufacturing a pyrotechnic pellet for use with a thermal battery in accordance with the disclosed subject matter. The method 1300 will be described hereinafter with reference to FIGS. 1 to 6B.

At step 1302, the volume of iron oxide powder 302 is pressed to form the iron oxide pellet 308, as illustrated in FIG. 3. In some embodiments, the pressing of the volume of iron oxide powder 302 into the iron oxide pellet 308 can be performed using the pelletization process 202. The pelletization process 202 is configured to compress or mold a material into the shape of a pellet. In some embodiments, the pelletization process 202 may include the pellet press 304 to perform the pelletization process 202. The pellet press can be any type of press, such as, but not restricted to, a mechanical press, a hydraulic press, or an isostatic press. In some embodiments, the iron oxide pellet 308 can be cylindrical, cuboidal, disc-shaped, or otherwise as needed for the particular thermal battery 100 being constructed. In an embodiment, the shape and size of the iron oxide pellet 308 is chosen based on specifications of the thermal battery 100 (shown in FIG. 1).

The method 1300 further includes pre-sintering the iron oxide pellet 308 in air using the pre-sintering process 204. The pre-sintering process 204 removes impurities, residual moisture, binders, and lubricants from the iron oxide pellet 308. The pre-sintering process 204 starts with a gradual heating of the iron oxide pellet 308 in the pre-sintering furnace 402 from room temperature to a predefined temperature ‘T1’. In some embodiments, the predefined temperature ‘T1’ can be approximately 800° C. The predefined temperature ‘T1’ may vary in accordance with the impurities present in the iron oxide pellet 308. At the predefined temperature ‘T1’, the impurities associated with the iron oxide pellet 308 are burnt out to form the pre-sintered iron oxide pellet 404. In some embodiments, multiple iron oxide pellets 308 may be simultaneously subjected to the pre-sintering process 204. In alternative embodiments, the pre-sintering process 204 may be optional and the iron oxide pellet 308 may be directly subjected to the reduction process 206.

At step 1304, the pre-sintered iron oxide pellet 404 is reduced to the iron pellet 506 made of metallic iron by the reduction process 206. In some embodiments, the pre-sintered iron oxide pellet 404 is exposed to hydrogen gas at a predetermined range of temperature for carrying out the reduction process 206. In some other embodiments, the pre-sintered iron oxide pellet 404 is reduced to the iron pellet 506 by exposing the pre-sintered iron oxide pellet 404 to some other reductant gas or compound. In other embodiments, carbon based reductants, such as coke and/or carbon monoxide, may also be used. Further, the reduction process 206 may also impart a desired porosity to the reduced iron pellet 506.

In some embodiments, the reduction process 206 may be used to reduce the pre-sintered iron oxide pellet 404 to the reduced iron pellet 506 in the reduction furnace 502. The reduction furnace 502 may be provided with the opening 504 at the top. The opening 504 is provided for entry of reductant gases required for the reduction of the iron oxide present in the pre-sintered iron oxide pellet 404. In further embodiments, multiple pre-sintered iron oxide pellets 404 may be simultaneously subjected to the reduction process 206 within the reduction furnace 502. In some embodiments, the reduction process 206 may also improve the strength of the iron pellet 506 due to in situ sintering. The reduction process 206 may also remove any residual impurities from the iron pellet 506, thereby improving its purity.

Next at step 1306, the reduced iron pellet 506 is impregnated with an oxidizer to form the pyrotechnic pellet 210. The iron pellet 506 can be impregnated by either the first impregnation process 208a (shown in FIG. 6A) or the second impregnation process 208b (shown in FIG. 6B). In some embodiments, as per the first impregnation process 208a, the impregnation of the iron pellet 506 may include spraying the iron pellet 506 with the solution 606 of the oxidizer and the solvent. The porosity of the reduced iron pellet 506 helps the oxidizer to infuse with the iron pellet 506 to form the pyrotechnic pellet 210. In some embodiments, the oxidizer can be any compound which easily dissolves in the solvent. For example, the oxidizer can be, but is not restricted to, potassium perchlorate, potassium nitrate, or lithium perchlorate. Further, the solvent may be any chemical compound which is easily volatized so as to deposit the oxidizer on the surface of the iron pellets 1104. An example of the oxidizer-solvent solution can be lithium perchlorate and acetone. In some other embodiments, as per the second impregnation process 208b, the impregnation of the iron pellet 506 may include immersing the iron pellet 506 in the solution 606 of the oxidizer and the solvent.

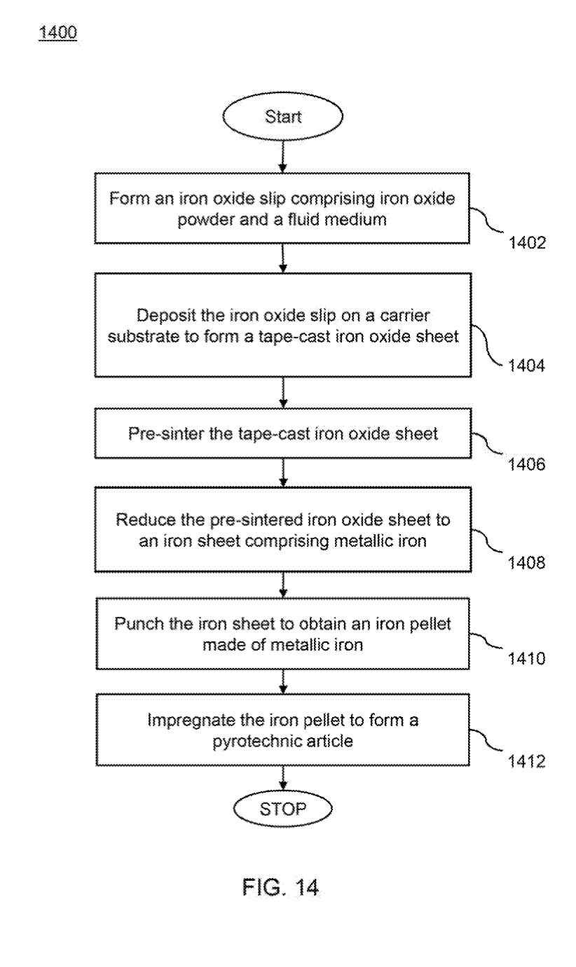

FIG. 14 is a flowchart of a method 1400 for manufacturing a pyrotechnic article for use in a thermal battery in accordance with the disclosed subject matter. The method 1400 will be described hereinafter with reference to FIGS. 7 to 11 and FIGS. 6A and 6B.

At step 1402, the method 1400 includes forming an iron oxide slip 802 comprising iron oxide powder and a fluid medium. The fluid medium may include a solvent, a dispersant, a binder, and a plasticizer. The solvent present in the fluid medium may be used to dissolve and homogeneously distribute the other slip components. The dispersant disperses the particles in the iron oxide slip 802 to keep them apart and homogeneously suspended in the iron oxide slip 802. The polymeric binder holds various components of the iron oxide slip 802 together. The plasticizer is added to the iron oxide slip 802 to add flexibility to the tape-cast iron oxide sheet 810. Further, at step 1404, the iron oxide slip 802 may be deposited on the carrier substrate 808 with the iron oxide slip 802 to form the tape-cast iron oxide sheet 810. Steps 1402 and 1404 are therefore part of the tape-casting process 702.

At step 1406, the tape-cast iron oxide sheet 810 is pre-sintered to remove impurities, residual moisture, binders, and lubricants from the tape-cast iron oxide sheet 810 to form the pre-sintered iron oxide sheet 904. In some other embodiments, the pre-sintering process 704 may be used to pre-sinter the tape-cast iron oxide sheet 810. The pre-sintering process 704 starts with a gradual heating of the tape-cast iron oxide sheet 810 in the pre-sintering furnace 902 from room temperature to a predefined temperature ‘T3’. In some embodiments, the predefined temperature ‘T3’ can be approximately 800° C. The predefined temperature ‘T3’ may vary in accordance with the impurities present in the tape-cast iron oxide sheet 810. At the predefined temperature ‘T3’, the impurities associated with the tape-cast iron oxide sheet 810 are burnt out to form the pre-sintered iron oxide sheet 904. The pre-sintering process 704 may also improve strength characteristics of the tape-cast iron oxide sheet 810. In some embodiments, the pre-sintering process 704 may be conducted in presence of air. Further, a pressure of air within the pre-sintering furnace 902 may be increased above atmospheric pressure to obtain a desired compaction of the tape-cast iron oxide sheet 810. In alternative embodiments, the pre-sintering process 704 may be optional, and the tape-cast iron oxide sheet 810 may be directly subjected to the reduction process 706.

At step 1408, the pre-sintered iron oxide sheet 904 is reduced into the iron sheet 1006 comprising metallic iron by the reduction process 706, as illustrated in FIG. 10. The reduction process 706 may be carried out in the reduction furnace 1002. The reduction furnace 1002 may be provided with the opening 1004 at the top. The opening 1004 is provided for entry of reductant gases required for the reduction of the iron oxide present in the pre-sintered iron oxide sheet 904. In an exemplary embodiment, the reduction process 706 is carried out in the presence of hydrogen gas. In other embodiments, carbon based reductants, such as coke and/or carbon monoxide, may also be used. The pre-sintered iron oxide sheet 904 contacts and reacts with the hydrogen at a temperature ‘T4’ for carrying out the reduction process 706. In some embodiments, the temperature ‘T4’ lies in a range from about 500 to 1000° C. In other embodiments, the temperature ‘T4’ lies in a ranges from about 600 to 800° C. In some embodiments, a predetermined pressure may also be maintained within the reduction furnace 1002 to facilitate the reduction of the pre-sintered iron oxide sheet 904 to the iron sheet 1006. Further, the reduction process 706 may also impart a desired porosity to the reduced iron sheet 1006. In some embodiments, the reduction process 706 may also improve the strength of the iron sheet 1006 due to in situ sintering. The reduction process 706 may also remove any residual impurities from the iron sheet 1006, thereby improving its purity.

Further, at step 1410, the iron pellet 1104 made of metallic iron is punched out from the iron sheet 1006. The punching process 708 involves the punch 1102 that punches out the iron pellets 1104 from the iron sheet 1006. In an exemplary embodiment, the punch 1102 is cylindrical in shape in order to form disc-shaped iron pellets 1104 with desired dimensions. In some other embodiments, the punch 1102 can have different shape and size based on the desired shape and size of the iron pellets 1104. Further, the punching process 708 can be performed automatically or manually. The punching process 708, as illustrated in FIG. 11, is exemplary in nature, and embodiments are intended to include or otherwise cover any other process to punch out the iron pellets 1104 from the iron sheet 1006.

At step 1412, the iron pellets 1104 are impregnated with an oxidizer to form the pyrotechnic article 712. In some embodiments, the impregnation process 710 may be substantially similar to the first impregnation process 208a, as described above with reference to FIG. 6A. Specifically, spraying the solution 606 of the oxidizer and the solvent on one or more of the iron pellets 1104. The porosity of the reduced iron pellet 1104 helps the oxidizer to infuse with the iron pellet 1104 to form the pyrotechnic article 712. In some embodiments, the oxidizer can be any compound which easily dissolves in the solvent. For example, the oxidizer can be, but is not restricted to, potassium perchlorate, potassium nitrate, or lithium perchlorate. Further, the solvent may be any chemical compound which is easily volatized so as to deposit the oxidizer on the surface of the iron pellets 1104. An example of the oxidizer-solvent solution can be lithium perchlorate and acetone.

In other embodiments, the impregnation process 710 may be substantially similar to the second impregnation process 208b, as described above with reference to FIG. 6B. Specifically, the impregnation process 710 can also be performed by immersing the iron pellets 1104 into the solution 606 of the oxidizer and the solvent. The impregnation process 710 produces the pyrotechnic article 712. The first and second impregnation processes 208a and 208b, as illustrated in FIGS. 6A and 6B, are exemplary in nature, and embodiments are intended to include or otherwise cover any other impregnation method to form the pyrotechnic material 712 from the iron pellets 1104.

### V. Alternative Embodiments

While certain embodiments of the invention are described above, and FIGS. 1 to 14 disclose the best mode for practicing the various inventive aspects, it should be understood that the invention can be embodied and configured in many different ways without departing from the spirit and scope of the invention.

Embodiments are disclosed above in the context of manufacturing a pyrotechnic material, a pyrotechnic article or a heat pellet for use in an electrochemical device, such as a thermal battery.

Embodiments are intended to cover forming an iron oxide preform from iron oxide powder, optionally pre-sintering the iron oxide preform, reducing the iron oxide preform to an iron preform, and then impregnating the iron preform with an oxidizer to obtain the pyrotechnic material, the pyrotechnic article, or the heat pellet for use with the electrochemical device. The iron oxide preform can formed by pelletization or tape-casting. Since the iron preform is formed prior to impregnation with the oxidizer, any risks of fire associated with the blending, handling, and pressing of iron powder in the presence of the oxidizer can be eliminated. The manufacturing process also directly starts with inexpensive iron oxide powder and eliminates one or more additional steps. The reduction process, that is used for reducing the iron oxide preform, can also be carried out without any substantial modifications to present equipment and method. As a result, the manufacturing process, according to the disclosed subject matter, is safe, inexpensive, and time-efficient.

Embodiments are intended to include a manufacturing process that includes forming an iron oxide pellet from iron oxide powder using a pelletization process, optionally pre-sintering the iron oxide pellet, reducing the iron oxide pellet to an iron pellet made substantially of metallic iron, and then impregnating the iron pellet with an oxidizer to obtain the pyrotechnic material, the pyrotechnic article, or the heat pellet.

Embodiments are intended to include a manufacturing process that includes forming a tape-cast iron oxide sheet from iron oxide powder using a tape-casting process, optionally pre-sintering the tape-cast iron oxide sheet, reducing the iron oxide sheet to an iron sheet made substantially of metallic iron, punching the iron sheet to obtain iron pellets, and then impregnating the iron pellets with an oxidizer to obtain the pyrotechnic material, the pyrotechnic article or the heat pellet.

Embodiments are also intended to include any type of pelletization process, tape-casting process, pre-sintering process, reduction process, punching process, and impregnation process for manufacturing the pyrotechnic material, the pyrotechnic article, or the heat pellet. One or more of the aforementioned processes can be manual, semi-automatic, or fully automatic. Embodiments are also intended to cover any computer-controlled machine or equipment for carrying out one or more of the aforementioned processes.

Embodiments are also intended to cover any additional process that can be performed on the pyrotechnic material or the pyrotechnic article before being used in the electrochemical device. Examples of such additional processes can include machining, heat treatment, coating, surface finishing, and so forth.

Embodiments are further intended to cover any industrial process, for example, but not limited to, assembly line production, batch production, job production, mass production, and the like. Further, all the processes can be executed at a single location or at multiple locations.

While the subject matter has been described in detail with reference to exemplary embodiments thereof, it will be apparent to one skilled in the art that various changes can be made, and equivalents employed, without departing from the scope of the invention. All related art references discussed in the above Background section are hereby incorporated by reference in their entirety.

What is claimed is:

1. A method of manufacturing a pyrotechnic article for use with a thermal battery, the method comprising:
forming an iron oxide preform from iron oxide powder;
reducing the iron oxide preform to an iron preform made of metallic iron; and
impregnating the iron preform with an oxidizer to form the pyrotechnic article.

2. The method of claim 1, wherein the iron oxide preform is an iron oxide pellet, and wherein forming the iron oxide preform comprises pressing a volume of iron oxide powder to form the iron oxide pellet.

3. The method of claim 1, wherein the iron oxide preform is a tape-cast iron oxide sheet, and wherein forming the iron oxide preform comprises:
forming an iron oxide slip comprising iron oxide powder and a fluid medium; and
depositing the iron oxide slip on a carrier substrate to form the tape-cast iron oxide sheet.

4. The method of claim 1, further comprises pre-sintering the iron oxide preform.

5. The method of claim 1, wherein reducing the iron oxide preform to the iron preform comprises exposing the iron oxide preform to hydrogen gas at a predetermined range of temperature to reduce iron oxide to metallic iron.

6. The method of claim 1, wherein impregnating the iron preform comprises spraying the iron preform with a solution of the oxidizer and a solvent or immersing the iron preform in a solution of the oxidizer and a solvent.

7. The method of claim 6, wherein the oxidizer is lithium perchlorate and the solvent is acetone.

8. The method of claim 1, wherein the oxidizer is potassium perchlorate.

9. A method of manufacturing a pyrotechnic pellet for use with a thermal battery, the method comprising:
pressing a volume of iron oxide powder to form an iron oxide pellet;
reducing the iron oxide pellet to an iron pellet made of metallic iron; and
impregnating the iron pellet with an oxidizer to form the pyrotechnic pellet.

10. The method of claim 9, further comprises pre-sintering the iron oxide pellet in air.

11. The method of claim 9, wherein reducing the iron oxide pellet to the iron pellet comprises exposing the iron oxide pellet to hydrogen gas at a predetermined range of temperature to reduce iron oxide to metallic iron.

12. The method of claim 9, wherein impregnating the iron pellet comprises spraying the iron pellet with a solution of the oxidizer and a solvent or immersing the iron pellet in a solution of the oxidizer and a solvent.

13. The method of claim 12, wherein the oxidizer is lithium perchlorate and the solvent is acetone.

14. The method of claim 9, wherein the oxidizer is potassium perchlorate.

15. A method of manufacturing a pyrotechnic article for a thermal battery, the method comprising:
forming an iron oxide slip comprising iron oxide powder and a fluid medium;
depositing the iron oxide slip on a carrier substrate to form a tape-cast iron oxide sheet;
pre-sintering the tape-cast iron oxide sheet;
reducing the pre-sintered iron oxide sheet to an iron sheet comprising metallic iron;
punching the iron sheet to obtain an iron pellet made of metallic iron; and
impregnating the iron pellet with an oxidizer to form the pyrotechnic article.

16. The method of claim 15, wherein impregnating the iron pellet comprises spraying the iron pellet with a solution of the oxidizer and a solvent.

17. The method of claim 15, wherein impregnating the iron pellet comprises immersing the iron pellet in a solution of the oxidizer and a solvent.

18. The method of claim 16, wherein the oxidizer is lithium perchlorate and the solvent is acetone.

19. The method of claim 17, wherein the oxidizer is lithium perchlorate and the solvent is acetone.

20. The method of claim 19, wherein the oxidizer is potassium perchlorate.
